(19) United States
(12) Patent Application Publication
(10) Pub. No.: US 2024/0332482 A1
(43) Pub. Date: Oct. 3, 2024

(54) Method and Apparatus for Processing Electrode Sheet

(71) Applicant: LG Energy Solution, Ltd., Seoul (KR)

(72) Inventors: Hyuk Soo Lee, Daejeon (KR); Tae Su Kim, Daejeon (KR); Dong Hyeuk Park, Daejeon (KR); Seo Jun Lee, Deajeon (KR); Hyojin Lee, Daejeon (KR); Gil Woo Kim, Daejeon (KR); Jung Hyun Park, Daejeon (KR); Byunghee Lee, Daejeon (KR)

(73) Assignee: LG Energy Solution, Ltd., Seoul (KR)

(21) Appl. No.: 18/580,015

(22) PCT Filed: Jul. 12, 2022
(86) PCT No.: PCT/KR2022/010132

§ 371 Date: Jan. 17, 2024

(30) Foreign Application Priority Data
Jul. 19, 2021 (KR) 10-2021-0094432
Jul. 7, 2022 (KR) 10-2022-0083589

(51) Int. Cl. H01M 4/04; H01M 4/02

(52) U.S. Cl. CPC H01M 4/0404; H01M 4/0409; H01M 2004/028

(57) ABSTRACT

One embodiment of the present invention provides an electrode sheet processing method comprising the steps of preparing an electrode sheet having an electrode mixture layer disposed on at least one surface of the electrode current collector; removing a part of the electrode mixture layer in the thickness direction by physical processing; and cutting down the region from which the electrode mixture layer of the electrode sheet is removed.

### TECHNICAL FIELD

This application claims the benefits of priorities based on Korean Patent Application No. 10-2021-0094432 filed on Jul. 19, 2021 and Korean Patent Application No. 10-2022-0083589 filed on Jul. 7, 2022, the entire contents of which are incorporated herein by reference.

The present invention relates to an electrode sheet processing method and processing apparatus.

### BACKGROUND ART

As technology development and demand for mobile devices increase, rechargeable secondary batteries are widely used as energy sources for various mobile devices. In addition, the secondary battery is also attracting attention as an energy source for electric vehicles, hybrid vehicles, etc., which are being proposed as a way to solve the air pollution of existing gasoline or diesel vehicles.

The secondary battery is classified into a coin-type battery, a cylindrical battery, a prismatic battery, and a pouch-type battery depending on the shape of the battery case in which the electrode assembly is embedded. In general, an electrode assembly embedded in a battery case is classified into a jelly-roll type wound with a separator interposed between a positive electrode and a negative electrode, a stack type in which a plurality of unit cells with a separator interposed between a positive electrode and a negative electrode are stacked, and a stack/folding type in which unit cells are wound with a separation film.

Such a secondary battery may be manufactured by processing an electrode sheet in which an electrode mixture comprising an electrode active material, a conductive agent, and a binder is applied on an electrode current collector, to obtain an electrode, and stacking the prepared electrode together with a separator, and then embedding and sealing them in a battery case together with an electrolyte solution.

Meanwhile, the electrode sheet can be processed using a mold or laser processing, etc., and laser processing is preferred for more precise processing. However, the laser processing has a problem in that it is difficult to apply when processing an electrode sheet having a thick thickness.

### Disclosure

### Technical Problem

One embodiment of the present invention is to provide an electrode sheet processing method and processing apparatus with improved process productivity.

One embodiment of the present invention is to provide an electrode sheet processing method and processing apparatus capable of reducing spatter and heat generation.

One embodiment of the present invention is to provide an electrode sheet processing method and processing apparatus with improved processing quality.

One embodiment of the present invention is to provide an electrode sheet processing method and processing apparatus capable of reducing the cost.

One embodiment of the present invention is to provide an electrode sheet processing method and processing apparatus capable of correcting the shaking of the electrode sheet during processing.

One embodiment of the present invention is to provide an electrode sheet processing method and processing apparatus capable of improving the alignment of a processing region.

### Technical Solution

According to one embodiment of the present invention, the above tasks can be achieved by first removing a part of the electrode mixture layer in the thickness direction and then cutting down the electrode sheet. At this time, a part of the electrode mixture layer may be removed by physical processing. The cutting down may be a notching or a cutting.

For example, the electrode sheet processing method according to one embodiment of the present invention comprises the steps of preparing an electrode sheet having an electrode mixture layer disposed on at least one surface of the electrode current collector; removing a part of the electrode mixture layer in the thickness direction by physical processing; and cutting down the region from which the electrode mixture layer of the electrode sheet is removed.

As another example, the electrode sheet processing apparatus according to one embodiment of the present invention comprises a conveying portion for conveying an electrode sheet having an electrode mixture layer disposed on at least one surface of the electrode current collector; a first processing portion for removing a part of the electrode mixture layer in the thickness direction by physical processing; and a second processing portion for cutting down the region from which the electrode mixture layer of the electrode sheet is removed.

### Advantageous Effects

According to one embodiment of the present invention, it is possible to provide an electrode sheet processing method and processing apparatus with improved process productivity.

According to one embodiment of the present invention, it is possible to provide an electrode sheet processing method and processing apparatus capable of preventing spatter and heat generation.

According to one embodiment of the present invention, it is possible to provide an electrode sheet processing method and processing apparatus with improved processing quality.

One embodiment of the present invention can provide an electrode sheet processing method and processing apparatus capable of reducing the cost.

One embodiment of the present invention is to provide an electrode sheet processing method and processing apparatus capable of correcting the shaking of the electrode sheet during processing.

One embodiment of the present invention may provide an electrode sheet processing method and processing apparatus capable of improving the alignment of the processing region.

However, the effects of the present invention are not limited to the above-described effects, and the present invention may have other effects that can be recognized by those skilled in the art with reference to the present specification and the accompanying drawings.

### DESCRIPTION OF DRAWINGS

FIG. 1 is a flowchart of the electrode sheet processing method according to one embodiment of the present invention.

FIG. 2 is a schematic view of the electrode sheet processing apparatus according to one embodiment of the present invention.

FIG. 3 is a plan view of the electrode sheet according to one embodiment of the present invention.

### MODE FOR INVENTION

Hereinafter, embodiments of the present invention will be described in detail with reference to the accompanying drawings. However, it will be apparent to those skilled in the art that the present invention is not limited to the accompanying drawings or the contents described in this specification, and the present invention can be implemented in various forms without departing from the technical spirit of the present invention. In addition, in the accompanying drawings to help the understanding of the invention, the configuration may be shown exaggerated to some extent, and some configurations may be omitted.

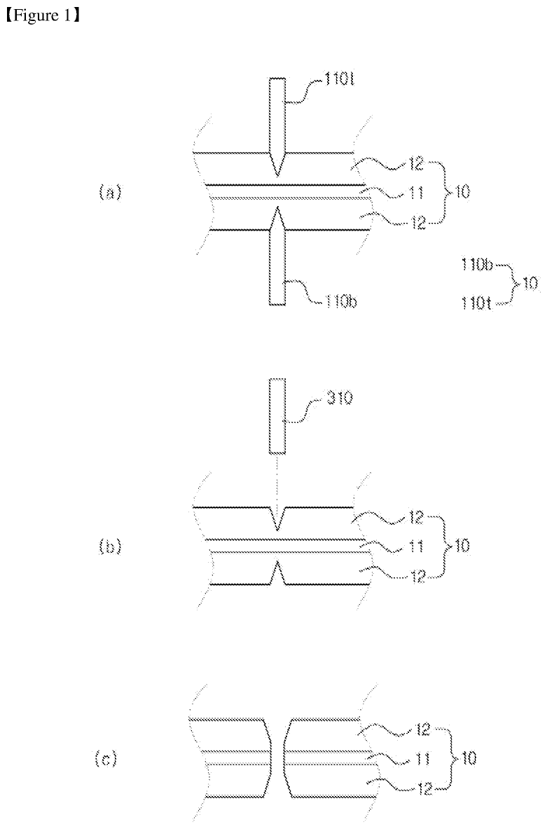

FIG. 1 is a flowchart of an electrode sheet processing method according to one embodiment of the present invention.

One embodiment of the electrode sheet processing method according to the present invention may comprise the steps of preparing an electrode sheet 10 having an electrode mixture layer 12 disposed on at least one surface of the electrode current collector 11; removing a part of the electrode mixture layer 12 in the thickness direction by physical processing; and cutting down the region from which the electrode mixture layer 12 of the electrode sheet 10 is removed.

Hereinafter, each step and configuration of one embodiment of the present invention will be described in more detail. Meanwhile, it should be noted in advance that the region of the electrode sheet 10 to be processed is not particularly limited and may be variously modified according to the intention of the practitioner.

One embodiment of the electrode sheet processing method according to the present invention comprises a step of preparing an electrode sheet 10 having an electrode mixture layer 12 disposed on at least one surface of the electrode current collector 11.

The electrode sheet 10 comprises an electrode current collector 11 and an electrode mixture layer 12. As a material for forming the electrode current collector 11 and the electrode mixture layer 12, a known material may be used. The electrode mixture layer 12 is disposed on at least one surface of the electrode current collector 11. As shown in the drawing, the electrode mixture layer 12 may be disposed on each of both surfaces of the electrode current collector 11. The thickness of the electrode mixture layer 12 disposed on each of both surfaces of the electrode current collector 11 may be the same as or different from each other. In addition, the electrode mixture layer 12 may be disposed only on one surface of the electrode current collector 11.

The electrode sheet 10 may comprise a holding part in which the electrode mixture layer 12 is disposed on the electrode current collector 11, and a non-holding part in which the electrode mixture layer 12 is not disposed on the electrode current collector 11. The non-holding part may be one or both ends of the electrode sheet 10.

In addition, the electrode sheet processing method according to one embodiment of the present invention comprises a step of removing a part of the electrode mixture layer 12 in the thickness direction by physical processing.

As used herein, the “thickness direction” is a direction in which the electrode mixture layer 12 is stacked on the electrode current collector 11. In other words, the “thickness direction” is the direction from the electrode current collector 11 to the electrode mixture layer 12. Accordingly, the “thickness direction” may be a direction perpendicular to one surface of the electrode sheet 10, one surface of the electrode current collector 11 and/or one surface of the electrode mixture layer 12.

The electrode mixture layer 12 removes a portion in the thickness direction, and thus in the above step, the electrode current collector 11 may not be exposed. However, depending on the design, it is also possible to expose the electrode current collector 11 by removing all of the electrode mixture layer 12 in the thickness direction and it is also possible to further remove a part of the electrode current collector 11. For example, the electrode mixture layer 12 may be processed to have a thickness of less than 30% of the thickness before processing, but is not limited thereto, and the processing depth of the electrode mixture layer 12 can be adjusted according to the design.

A processing method for removing a part of the electrode mixture layer 12 in the thickness direction is not particularly limited, and may be a physical processing, a laser processing, or the like. However, the processing method for removing a part of the electrode mixture layer 12 in the thickness direction may preferably be a physical processing. The physical processing refers to a process of processing in direct contact with the electrode mixture layer 12 to be processed.

According to one embodiment of the present invention, the productivity and processing quality of the process can be improved by removing a part of the electrode mixture layer 12 to reduce the thickness of the electrode sheet 10 and then cutting down the electrode sheet 10. In addition, removing the part of the electrode mixture layer 12 through physical processing can improve processing quality by reducing spatter and heat generation, as well as reduce costs, and thus may be preferable than laser processing. Furthermore, since the physical processing is performed in direct contact with the electrode sheet 10, it can correct the shaking of the electrode sheet 10 during processing.

The physical processing can be performed by a blade 110. The blade may be a wheel, a knife, etc., but is not limited thereto, and can be used without limitation as long as it is a tool capable of performing processing in direct contact with the electrode mixture layer 12.

Meanwhile, as described above, the electrode mixture layer 12 may be disposed on each of both surfaces of the electrode current collector 11. In this case, removing the part of the electrode mixture layer 12 in the thickness direction by physical processing may be a process of removing a part of each of the electrode mixture layer 12 disposed on each of both surfaces of the electrode current collector 11. The electrode mixture layer 12 disposed on one surface of the electrode current collector 11 is removed with a first blade 110t, and the electrode mixture layer 12 disposed on the other surface of the electrode current collector 11 may be removed with a second blade 110b. Each of the electrode mixture layers 12 disposed on each of both surfaces of the electrode current collector 11 may be removed simultaneously or sequentially.

However, the step of removing a part of the electrode mixture layer 12 in the thickness direction by physical processing may be to remove only a part of any one of the electrode mixture layers 12 disposed on each of both surfaces of the electrode current collector 11. For example, this is because processing of both surfaces may not be necessary, if the thickness can be easily cut by laser processing in a later process, even if only the electrode mixture layer 12 disposed on one side of the electrode current collector 11 is removed and the electrode mixture layer 12 disposed on the other side of the electrode current collector 11 is not removed.

In the drawing, it is shown that a ‘V’-shaped groove is formed in the electrode mixture layer 12 through the physical processing, but the shape, size and the like of the groove formed in the electrode mixture layer 12 after physical processing is not particularly limited. The shape, size and the like of the grooves formed in each of the electrode mixture layers 12 disposed on each of both surfaces of the electrode current collector 11 may be the same as or different from each other.

In addition, the electrode sheet processing method according to one embodiment of the present invention comprises a step of cutting down the region from which the electrode mixture layer 12 of the electrode sheet 10 is removed.

At this time, a region of the electrode sheet 10 other than the region from which the electrode mixture layer 12 is removed may also be cut. That is, the step of cutting down the region from which the electrode mixture layer of the electrode sheet 10 is removed is not to be interpreted as being limited to the step of cutting down only the region from which the electrode mixture layer of the electrode sheet 10 is removed. For example, in the above step, the non-holding part of the electrode sheet 10 may be further cut. Alternatively, only a part of the region from which the electrode mixture layer 12 of the electrode sheet 10 is removed may be cut.

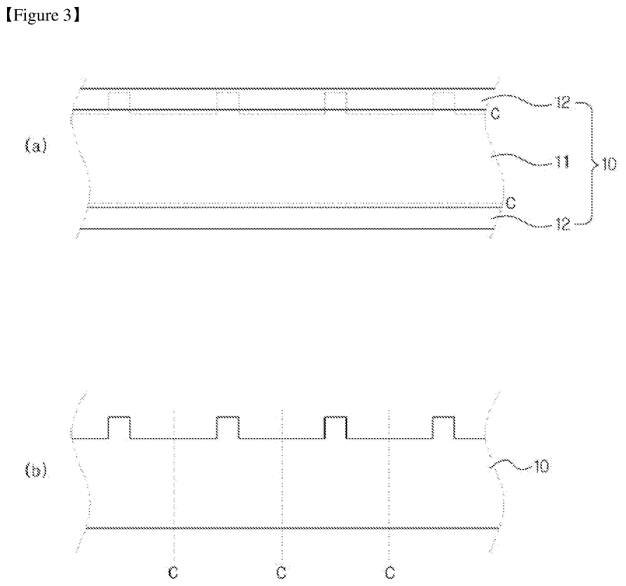

The cutting down may be a notching a cutting. The notching refers to the process of forming electrode tabs, and the cutting refers to the process of cutting the electrode sheet into individual electrodes. This will be further described in the description related to FIG. 3.

The cutting down may be performed by a laser 310 processing. At this time, the laser beam can be irradiated only on one surface of the electrode sheet 10 even when the electrode mixture layer 12 is disposed on each of both surfaces of the electrode current collector 11. However, if necessary, the laser beam may be irradiated on both surfaces of the electrode sheet 10. The cross-sectional area of the region processed by the laser 310 may be narrower than the cross-sectional area of the physically processed region. Here, the cross-sectional area means the region in a plane perpendicular to the thickness direction.

In addition, the electrode sheet processing method according to one embodiment of the present invention may comprise a step of detecting the region, from which the electrode mixture layer 12 of the electrode sheet 10 is removed, generating the position information, and transmitting the position information to a controller (not shown) that controls the laser 310.

The region from which the electrode mixture layer 12 of the electrode sheet 10 has been removed can be sensed through vision, and the alignment of the processing region may be improved by allowing the laser 310 to cut based on the sensed position information.

In addition, the electrode sheet processing method according to one embodiment of the present invention may further comprise a step of conveying the electrode sheet 10. The electrode sheet 10 may be conveyed by a roller rotating in one direction, but is not limited thereto.

In embodiments, the electrode sheet 10 may be used as a positive electrode. In the case of an electrode sheet for a negative electrode, it can be easily processed by one or two laser processes. However, when the positive electrode is processed only by the laser process, the laser process must be performed three or more times due to the physical properties of the positive electrode. Therefore, in order to reduce the cost incurred due to the laser process, it is preferable to proceed by a laser process after a physical process that can be carried out at a low cost is performed first. When the physical process is performed, the electrode sheet can be processed at a low cost as described above even if the laser process is performed only once.

As such, the present invention has the effect of processing the electrode sheet for the positive electrode by using both a physical process available at a low cost and a laser process capable of finely cutting. In addition, when processing the electrode sheet for the negative electrode according to the present invention, only the second processing portion 300 may be used.

In the above, the electrode sheet processing method according to one embodiment of the present invention has been described, but the electrode sheet processing method of the present invention is not limited to the above. For example, of course, the electrode sheet processing method according to one embodiment of the present invention may further comprise steps not described herein. In addition, some of the above-described steps may be omitted or the order of each step may be changed. In some cases, two or more of the above steps may be performed simultaneously.

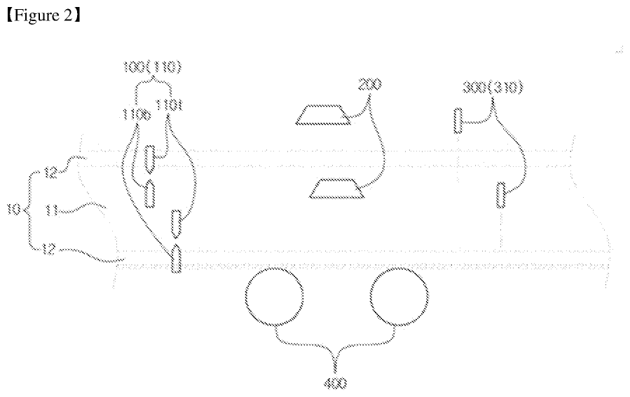

FIG. 2 is a schematic view of the electrode sheet processing apparatus according to one embodiment of the present invention.

One embodiment of the electrode sheet processing apparatus according to the present invention may comprise a first processing portion 100, a vision portion 200, a second processing portion 300 and a conveying portion 400.

Hereinafter, each configuration of one embodiment of the present invention will be described in more detail with reference to the drawings.

The first processing portion 100 removes a part of the electrode mixture layer 12 in the thickness direction by physical processing.

The first processing portion 100 may include a blade 110. A first blade 110t for removing the electrode mixture layer 12 disposed on one surface of the electrode current collector 11 and a second blade 110b for removing the electrode mixture layer 12 disposed on the other surface of the electrode current collector 11 may be comprised. However, when removing only the electrode mixture layer 12 disposed on one surface or the other surface of the electrode current collector 11, the blade 110 for cutting down a region of the electrode mixture layer 12 may be configured in a single number.

When removing each of the electrode mixture layers 12 disposed on each of both surfaces of the electrode current collector 11 at the same time, the first blade 110t and the second blade 110b may be disposed in regions overlapping each other in the thickness direction. When sequentially removing each of the electrode mixture layers 12 disposed on each of both surfaces of the electrode current collector 11, the first blade 110t and the second blade 110b may be disposed to be spaced apart from each other along the conveying direction of the electrode sheet 10.

The number of each of the first blade 110t and the second blade 110b is not particularly limited, and may be singular or plural. For example, as shown in the drawings, each of the first blade 110t and the second blade 110b may be disposed on each of both ends of the electrode sheet 10. When forming an electrode tab at one end of the electrode sheet and cutting the other end during the notching process, it may be arranged in such a structure. As another example, each of the first blade 110t and the second blade 110b may be disposed only at one end of the electrode sheet 10. For example, when cutting of the other end is not required during the notching process, it may be arranged in the above-described structure. However, the number and arrangement of the blades 110 are not particularly limited, and can be modified in any degree according to the region to be processed of the electrode sheet 10.

The vision portion 200 may detect the region form which the electrode mixture layer 12 of the electrode sheet 10 is removed, generate position information of the sensed region and then transmit the position information to a controller (not shown) that controls the laser 310. The controller may set a region to be processed by the laser 310 from the position information received from the vision portion 200. Through this, the alignment of the processing region can be improved by allowing the laser 310 to cut based on the sensed position information.

The vision portion 200 may also be disposed only on one surface of the electrode sheet 10 as shown in the drawing, or may also be disposed on both surfaces of the electrode sheet 10 differently as shown in the drawing. When a plurality of blades 110 are disposed on one surface of the electrode sheet 10, a plurality of vision portions 200 for sensing each region removed by each of the plurality of blades 110 may be disposed on one surface of the electrode sheet 10.

The second processing portion 300 cuts down the region from which the electrode mixture layer 12 of the electrode sheet 10 is removed.

The second processing portion 300 may include a laser 310. The number of lasers 310 is not particularly limited, and may be singular or plural. For example, the laser 310 may be disposed on each of both ends of the electrode sheet 10, as shown in the drawings. As another example, the laser 310 may be disposed only at one end of the electrode sheet 10. However, the number and arrangement of the lasers 310 are not particularly limited, and may be changed in any degree according to the region of the electrode sheet 10 to cut down, as in the blade 110.

In embodiments, the electrode sheet 10 may be used for a positive electrode. In the case of an electrode sheet for a negative electrode, it can be easily processed by one or two laser processes. However, if the positive electrode is processed only by the laser process, the laser process must be carried out three or more laser processes due to the physical properties of the positive electrode. Therefore, in order to reduce costs due to the laser process, it is preferable to proceed with the laser process after the first step of the physical process that can be carried out at a small cost. If the physical process is performed, the electrode sheet can be processed at a small cost as described above even if the laser process is progressed only once.

As such, the present invention has the effect of processing the electrode sheet for the positive electrode by using both a physical process available at a low cost and a laser process capable of finely cutting. In addition, when processing the electrode sheet for the negative electrode according to the present invention, only the second processing portion 300 may be used.

The conveying portion 400 conveys the electrode sheet 10 on which the electrode mixture layer 12 is disposed on at least one surface of the electrode current collector 11.

The conveying portion 400 may be a roller, and may convey the electrode sheet 10 by rotating in one direction. Of course, the number and position of the rollers are not limited to those shown in the drawings. However, the conveying portion 400 may be implemented with a conveyor belt or the like.

Other content may be applied substantially the same as the content described in FIG. 1, and thus detailed description thereof will be omitted.

FIG. 3 is a plan view of an electrode sheet according to one embodiment of the present invention.

Referring to FIG. 3(a), the electrode sheet 10 comprises a holding part in which the electrode mixture layer 12 is disposed on the electrode current collector 11 and a non-holding part in which the electrode mixture layer 12 is not disposed on the electrode current collector 11. The non-holding part is disposed at both ends of the electrode sheet 10.

In the notching process, some regions of the holding part are machined together with the non-holding part to form electrode tabs. Alternatively, an electrode tab may be formed by cutting down only one end of the electrode sheet 10. At this time, before cutting down by a laser, it is possible to improve the productivity of the notching process by first removing a part of the electrode mixture layer 12 of the holding part in the thickness direction according to one embodiment of the present invention.

FIG. 3(b) shows an electrode sheet 10 in which electrode tabs are formed after notching. The electrode sheet 10 may be separated into individual electrodes by cutting down along the processing portion c in the region between the electrode tabs. At this time, before cutting down by a laser, it is possible to improve the productivity of the cutting process by first removing a part of the electrode mixture layer 12 in the thickness direction according to one embodiment of the present invention.

However, the scope of application of the present invention is not limited to the above-described notching and cutting processes, and various processing processes of the electrode sheet 10 may be applied.

In the above, one embodiment of the present invention has been exemplarily described, but it is not intended to limit the embodiment of the present invention to the above-described embodiment. Those skilled in the art will be able to implement one embodiment of the present invention with appropriate modifications by omitting, changing, or substituting all or part of the configuration of the present invention with reference to the present specification and accompanying drawings or adding another configuration and so on, without departing from the technical spirit of the present invention.

In this specification, the order of the first, second, etc. is for distinguishing the components from each other, and does not mean a priority order between the components or an absolute order. A first element in one part of this specification may be referred to as a second element in another part of this specification.

The terms and expressions herein should be interpreted broadly and should not be construed in a limiting sense. In this specification, the expression ‘comprising’ does not exclude the presence or addition of one or more other components other than the stated components. In this specification, expression in the singular comprises the plural unless explicitly excluded by context. In addition, each of the embodiments can be combined with each other, and unless contradicted, the content described in a particular embodiment may also be applied to other embodiments.

1. An electrode sheet processing method, comprising:
preparing an electrode sheet by depositing an electrode mixture layer on at least one surface of an electrode current collector:
removing a part of the electrode mixture layer in a thickness direction of the electrode sheet by physical processing; and
cutting a region of the electrode sheet from which the electrode mixture layer has been removed.

2. The electrode sheet processing method according to claim 1, wherein the physical processing is performed with a blade.

3. The electrode sheet processing method according to claim 1, wherein the cutting is performed by a laser processing.

4. The electrode sheet processing method according to claim 3, further comprising:
sensing the region of the electrode sheet from which the electrode mixture layer has been removed;
generating position information of the region that has been sensed; and
then transmitting the position information to a controller for controlling a laser that performs the laser processing.

5. The electrode sheet processing method according to claim 1, wherein the cutting is a notching.

6. The electrode sheet processing method according to claim 1, wherein the at least one surface is disposed first and second opposite surfaces of the electrode current collector, and the removing of the part of the electrode mixture layer removes a part of the electrode mixture layer disposed on each of the first and second surfaces of the electrode current collector.

7. The electrode sheet processing method according to claim 1, wherein the electrode sheet is configured to be used as a positive electrode.

8. An electrode sheet processing apparatus, comprising:
a conveying portion configured to convey an electrode sheet having an electrode mixture layer disposed on at least one surface of an electrode current collector;
a first processing portion configured to remove a part of the electrode mixture layer in a thickness direction of the electrode sheet by physical processing; and
a second processing portion configured to cut a region from which the electrode mixture layer of the electrode sheet has been removed.

9. The electrode sheet processing apparatus according to claim 8, wherein the first processing portion comprises a blade.

10. The electrode sheet processing apparatus according to claim 8, wherein the second processing portion comprises a laser.

11. The electrode sheet processing apparatus according to claim 10, further comprising a vision portion configured to sense the region from which the electrode mixture layer of the electrode sheet has been removed, configured to generate position information of the region that has been sensed, and configured to transmit the position information to a controller for controlling the laser.

12. The electrode sheet processing apparatus according to claim 9, wherein the at least one surface is disposed on first and second opposite surfaces of the electrode current collector, and the blade comprises a first blade and a second blade together configured to remove a part of the electrode mixture layer disposed on each of the first and second surfaces of the electrode current collector.

13. The electrode sheet processing apparatus according to claim 8, wherein the electrode sheet is configured to be used as a positive electrode.
